(19) United States
(12) Patent Application Publication
(10) Pub. No.: US 2017/0059094 A1
(43) Pub. Date: Mar. 2, 2017

(54) BROADCAST LIGHTING DEVICE CAPABLE OF ADJUSTING COLOR TEMPERATURE

(71) Applicant: BARDWELL & MCALISTER INC., Sun Valley, CA (US)

(72) Inventor: Raymond E. Wolffe, Sun Valley, CA (US)

(21) Appl. No.: 14/842,673

(22) Filed: Sep. 1, 2015

(51) Int. Cl. F21K 99/00; H05B 37/02; F21V 23/06; F21V 14/02; F21V 19/00; F21V 15/015

(52) U.S. Cl. CPC F21K 9/175; F21V 19/0085; F21V 15/015; F21V 23/06; F21V 14/02; H05B 37/0245; F21W 2131/406

(57) ABSTRACT

Disclosed is a broadcast lighting device capable of adjusting a color temperature. The light broadcast lighting device includes a plurality of straight-type LED lamps controlled through a control unit and connected to a front surface of a casing through a set of main sockets, respectively, and each straight-type LED lamp includes a frame having mounting parts provided on at least two surfaces thereof, a substrate connected to the mounting part of the frame and mounted thereon with LED chips having mutually different color temperatures, a Cover plate to cover at least a portion of the frame, and a unit socket having at least two terminals protruding for electrical connection of at least one substrate and supporting both end portions of the Cover plate, thereby realizing various color temperatures.

### BACKGROUND OF THE INVENTION

1. Field of the Invention

The present invention relates to a broadcast lighting device capable of adjusting the color temperature, in which the light broadcast lighting device includes a plurality of straight-type LED lamps controlled through a control unit and connected to a front surface of a casing through a set of main sockets, respectively, and each straight-type LED lamp includes a frame having mounting parts provided on at least two surfaces thereof, a substrate connected to the mounting part of the frame and mounted thereon with LED chips having mutually different color temperatures, a Cover plate to cover at least a portion of the frame, and a unit socket having at least two terminals protruding for electrical connection of at least one substrate and supporting both end portions of the Cover plate, thereby realizing various color temperatures.

2. Description of the Related Art

In general, a lighting device has been extensively used in fields of films or videos in order to take a picture in a place, in which light is insufficient, or create an unusual atmosphere.

In this case, various kinds of lighting devices are provided in various shapes according to the uses.

For example, a lighting device used in the outdoors or studios to take a photograph or a video employs a light source such as a fluorescent lamp, a halogen lamp, a discharge lamp, or a metal halide lamp.

In detail, a lighting device including a fluorescent lamp, which has been extensively used, is generally used. The lighting device using the fluorescent lamp basically includes a support and a flat housing mounted on the support. A single lamp or a plurality of lamps are mounted in the flat housing, and the housing is provided at the front end thereof with a light collection plate to collect the light of a lamp in an open direction and irradiate the collected light.

However, since a color temperature of the lighting device using the fluorescent lamp may be changed when the lighting device is used for a predetermined time, the replacement period of the fluorescent lamp may become shorter than the reference use time of the fluorescent lamp in many cases.

Recently, in order to improve the problem occurring in the lighting device including a fluorescent lamp, a lighting device using a high efficiency light emitting diode (LED) has been developed.

The lighting device using the LED basically includes a strong and flat housing mounted on the support. The flat housing is provided therein with a printed circuit board, and the printed circuit board is mounted at the upper portion thereof with a plurality of LED modules. The housing is provided at the front end thereof with a transmissive panel so that the printed circuit board and the LED modules are not exposed to the outside.

However, the LED lighting device includes LED modules representing the same color, so that the realization of different color temperatures is difficult.

In order to improve the problems related to the adjustment of the color temperature, Korea Patent Registration No. 1261984 discloses the technology of a broadcast lighting device. The constitution of a broadcast lighting device 1 is shown in FIG. 1. The broadcast lighting device 1 includes a lighting housing 100 having a predetermined size, and a light source part having a light emitting part 210 is provided in the lighting housing 100. In addition, the lighting housing 100 is provided therein with a rotational part to rotate a light source part. A reflective plate is provided at the front surface of the lighting housing 100. The lighting housing 100 has a plurality of heat radiation holes 120 to discharge high-temperature heat, which is emitted as the light source part is operated, to the outside.

In addition, the broadcast lighting device 1 is fixed onto the LED included in the light source part. The broadcast lighting device 1 includes first a lens plate 510 to collect light emitted from the LED, and the reflective plate includes first and second reflective plates 402 and 404 provided at the upper and lower portions of the front surface of the lighting housing 100. The light source part has a structure in which a plurality of LEDs having mutually different color temperatures constitute the first to third light emitting parts 210a, 201b, and 201c.

In the broadcast lighting device 1, if a rotational part provided in the lighting housing 100 to rotate the light source part is rotated, the first to third light emitting parts 210a, 201b, and 201c are exposed in a forward direction so that mutually different color temperatures are realized.

However, in the broadcast lighting device, if one of the first to third light emitting parts 210a, 201b, and 201c is damaged, all of the first to third light emitting parts including a plurality of LEDs must be replaced, so that resources may be unnecessarily wasted.

In addition, each lighting device must be individually manipulated. Accordingly, when a plurality of lighting devices are required, the manipulation of the lighting devices may be difficult.

### SUMMARY OF THE INVENTION

The present invention has been made keeping in mind the problems occurring in the related art, and an object of the present invention is to provide a broadcast lighting device capable of adjusting a color temperature in which various color temperatures can be realized, the lighting suitable for the photographing condition can be formed, a color temperature can be rapidly changed through a simple manipulation, the color temperature can be rapidly adjusted though automation, and only one LED lamp can be replaced when the LED lamp is repaired to remove a cause of wasting resources.

In order to accomplish the above object, there is provided a broadcast lighting device capable of adjusting a color temperature. The light broadcast lighting device includes a plurality of straight-type LED lamps controlled through a control unit and connected to a front surface of a casing through a set of main sockets, respectively, and each straight-type LED lamp includes a frame having mounting parts provided on at least two surfaces thereof, a substrate connected to the mounting part of the frame and mounted thereon with LED chips having mutually different color temperatures, a Cover plate to cover at least a portion of the frame, and a unit socket having at least two terminals protruding for electrical connection of at least one substrate and supporting both end portions of the Cover plate.

In addition, the Cover plate has a shape of a cylinder into which the frame is inserted.

Further, the Cover plate is formed in a shape of an arc and connected to one lateral side of the frame.

Subsequently, the mounting parts of the frame are arranged at an interval of 180°.

In addition, the mounting parts of the frame are arranged at an interval of 120°.

In addition, the set of the main sockets to support the straight-type LED lamps is electrically connected to each other when the straight-type LED lamps are connected to each other.

Further, the set of the main sockets to support the straight-type LED lamps comprises a main socket to supply electricity and a dummy main socket.

In addition, the substrate is connected to both main sockets through mutually different terminals of both unit sockets.

In addition, one side of the substrate is connected to the main socket through a terminal of one main socket.

Further, the substrate includes a plurality of electrode plates representing positive and negative polarities, respectively, are arranged in opposition to each other when viewed on a plan view such that the electrode plates are electrically isolated from each other while representing a minimum electricity-isolation area with respect to a whole area of the substrate, insulating layers are laminated on a top and a bottom of the electrode plates to cover the top and the bottom of the electrode plates, a plurality of grounding holes are formed at one side of the insulating layer to expose the electrode plates, both polarities of the LED chips are directly grounded through the grounding holes to expose the electrode plates that are electrically isolated from each other, and electrically-isolated portions of the electrode plates, which are closely arranged in opposition to each other, form a zigzag pattern in which mutually different electrode plates are alternately arranged when viewed on a plan view.

Further, the LED lamp is mounted to rotate the Tube Body together with Side End Cap having the frame fixed thereto about the Side Cap socket to supply power to the substrate through a corresponding main AC Power Supply socket, and contact points connected to each substrate are provided at both end portions of the plate such that the contact points are exposed.

In addition, the LED lamp is mounted to rotate the Body having the frame fixed thereto about the Side End Cap to supply power to the substrate through one of the corresponding main AC power supply sockets, and contact points connected to each substrate are provided at both end portions of the LED Lighting plate such that the contact points are exposed.

Further, the LED lamp is mounted to rotate the Tube Body having the frame fixed thereto about the unit Side End socket by a first rotational unit to supply power to the substrate through a corresponding main socket into the Power Supply Unit of LED Plate, and contact points connected to each substrate are provided at both end portions of the LED Plate such that the contact points are exposed.

In addition, a plurality of substrates mounted in the frame receive power through unit sockets unto the Power Supply Unit provided at both sides of the substrates.

Further, a plurality of substrates mounted in the frame receive power through one unit End Side Cap socket.

In addition, the first rotational unit includes a first thread formed around an inner circumference of the Tube Body and a first driving motor which is installed in the unit socket and has a first driving gear.

In addition, the LED lamp is mounted to rotate the frame, which is mounted in the Tube Body to support the substrate, by a second rotational unit when the Tube Body is connected to the unit Side End Cap socket to supply power through a corresponding main socket.

Further, a plurality of substrates mounted in the frame receive power through unit sockets provided at both sides of the substrates.

Further, a plurality of substrates mounted in the frame receive power through one unit socket.

In addition, the second rotational unit includes a second thread protruding from the frame and a second driving motor which is mounted in the unit socket and has a second driving gear.

Subsequently, the control unit includes a communication module that makes wired or wireless communication to control all unit lighting devices or individually control the unit lighting devices by one controller.

As described above, according to the present invention, various color temperatures can be realized, the lighting suitable for the photographing condition can be formed, a color temperature can be rapidly changed through a simple manipulation, the color temperature can be rapidly adjusted through automation, and only one LED lamp can be replaced when the LED lamp is repaired to remove a cause of wasting resources.

### BRIEF DESCRIPTION OF THE DRAWINGS

FIG. 1 is a side view showing a lighting device according to the related art.

FIG. 2 is a perspective view the mounting state of a lighting device according to the present invention.

FIG. 3(a)-3(c) is an exploded view showing an LED lamp for a lighting device according to one embodiment of the present invention.

FIG. 4 is an exploded view showing an LED lamp according to another embodiment of the present invention.

FIGS. 5 and 6 are an exploded view and a side view showing an LED lamp according to still another embodiment of the present invention.

FIG. 7 is a side view showing an LED lamp according to a first embodiment of the present invention.

FIG. 8 is a side view showing an LED lamp according to a second embodiment of the present invention.

FIG. 9 is a side view showing an LED lamp according to a third embodiment of the present invention.

FIG. 10 is an exploded view showing an LED lighting substrate according to the present invention.

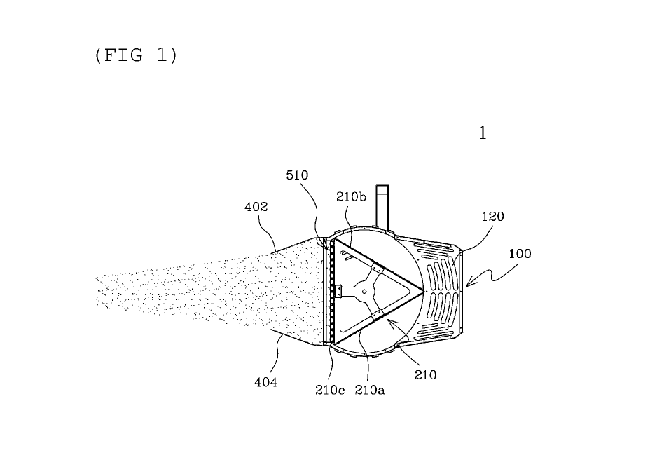

### DETAILED DESCRIPTION OF THE INVENTION

Hereinafter, the embodiments of the present invention will be described in detail with reference to accompanying drawings.

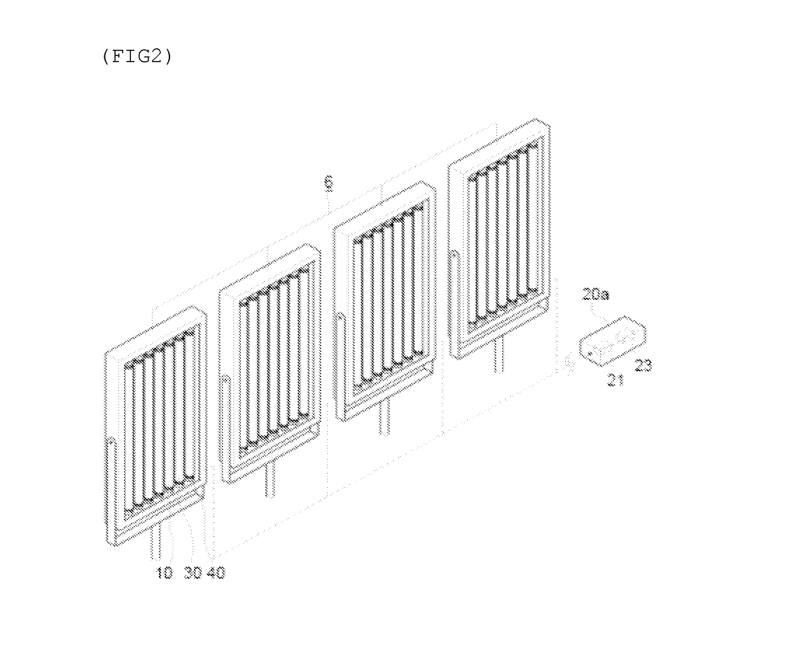

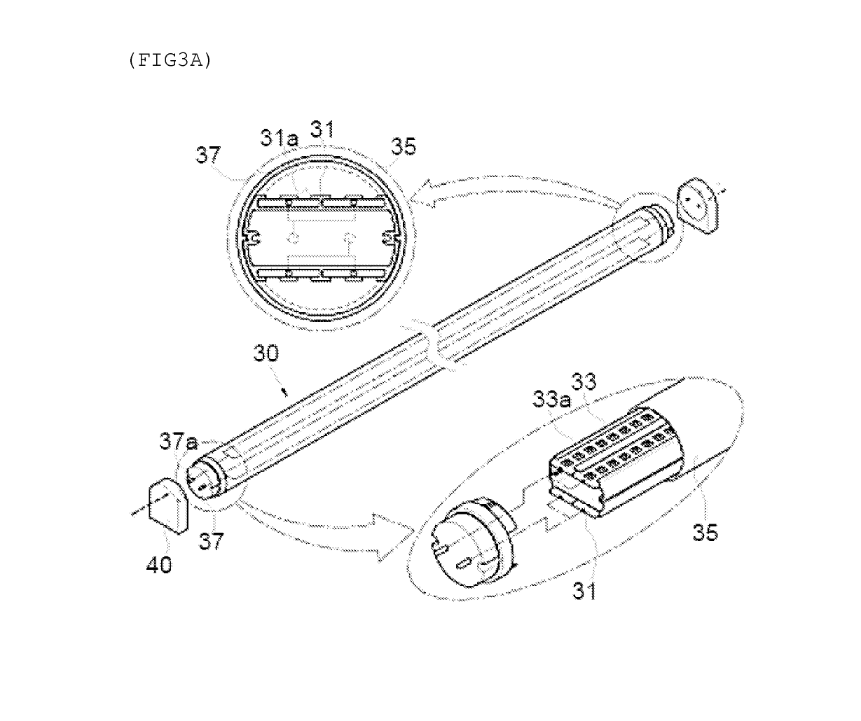

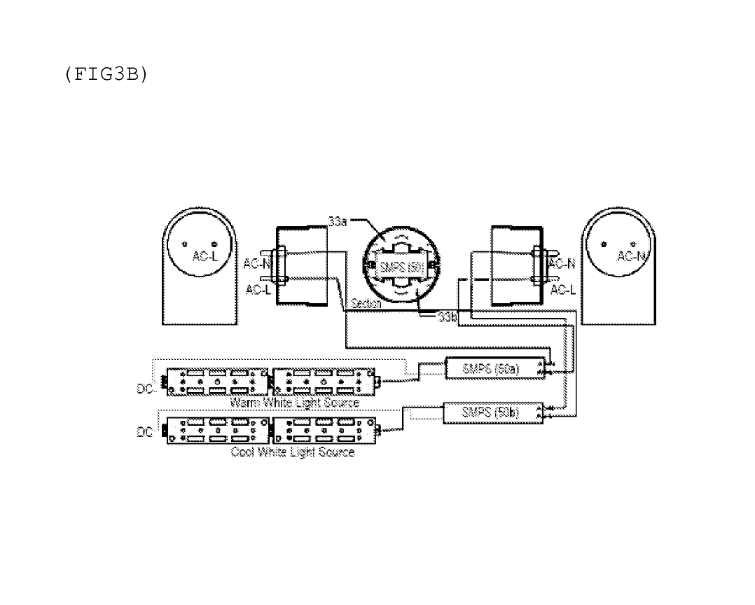

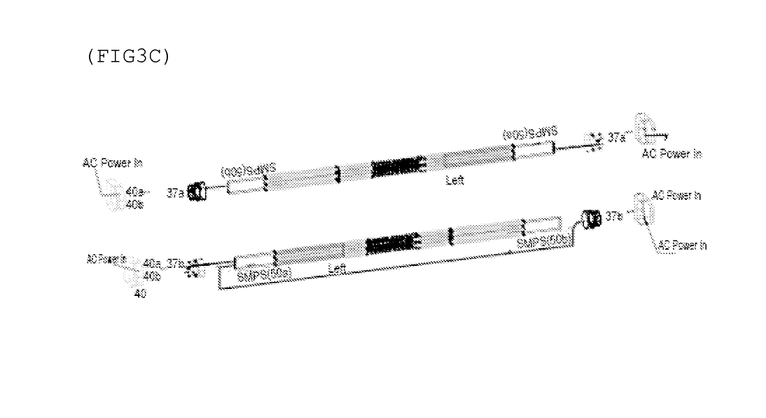

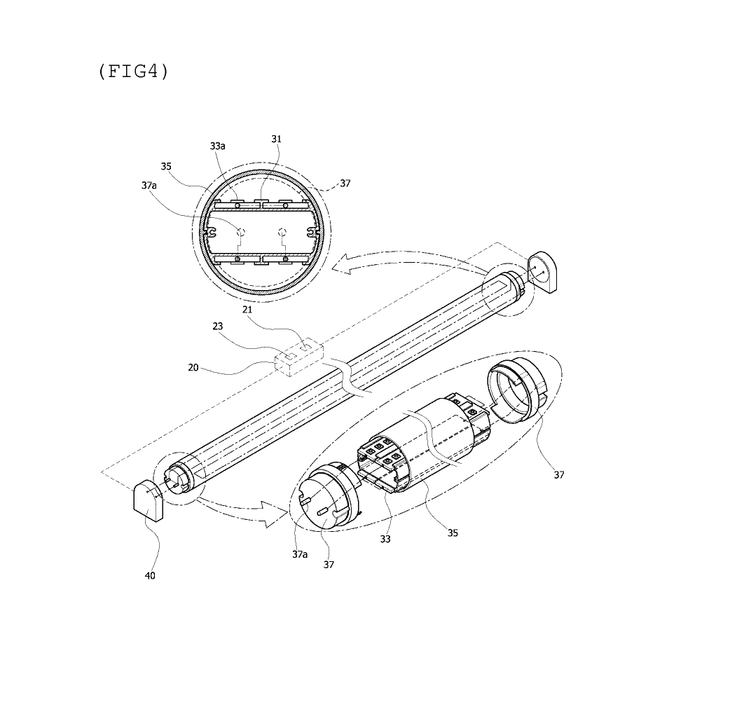

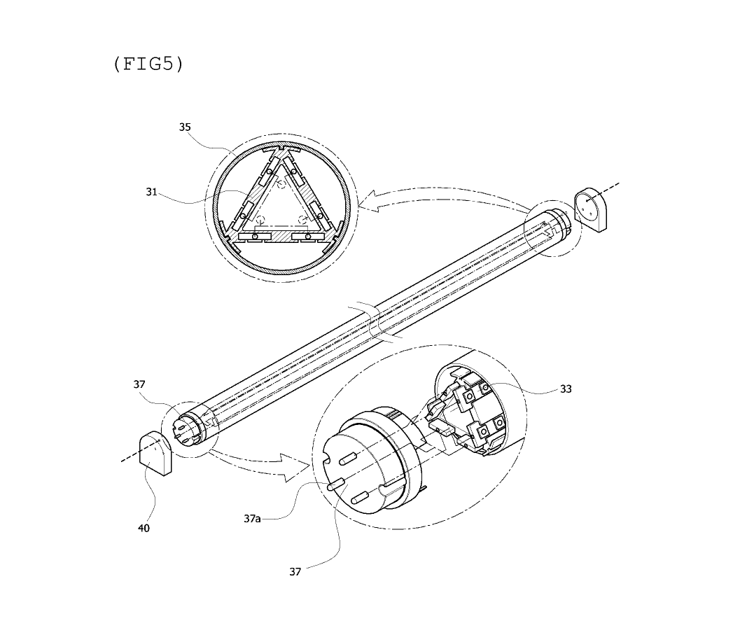

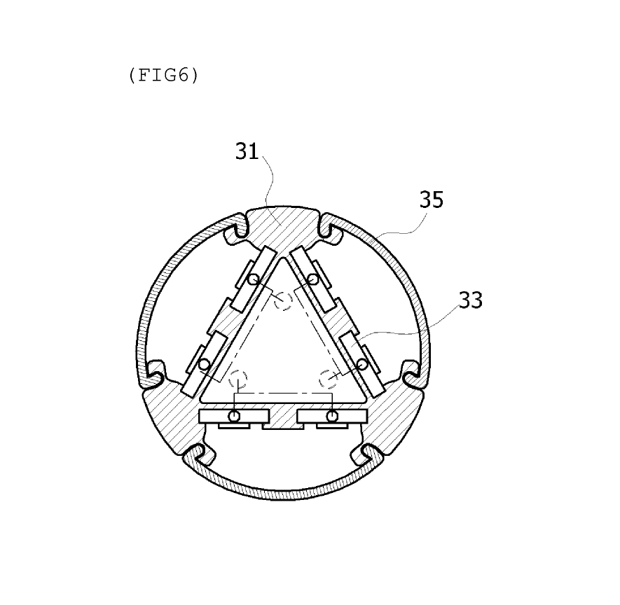

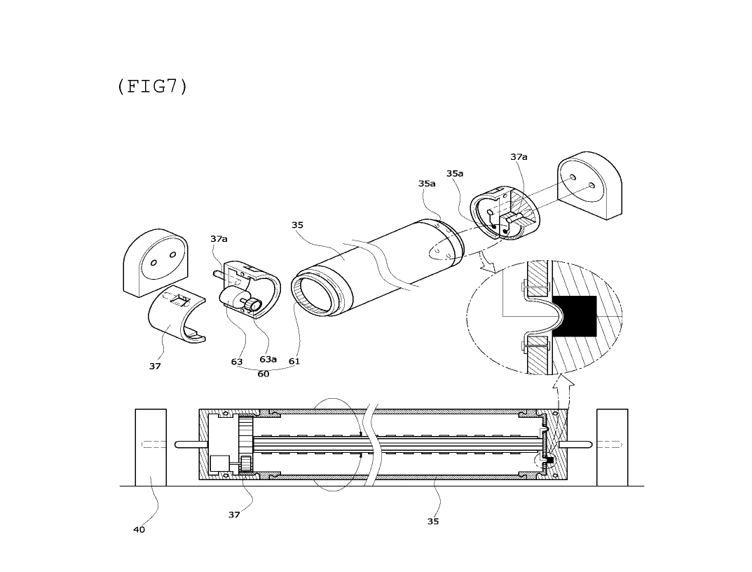

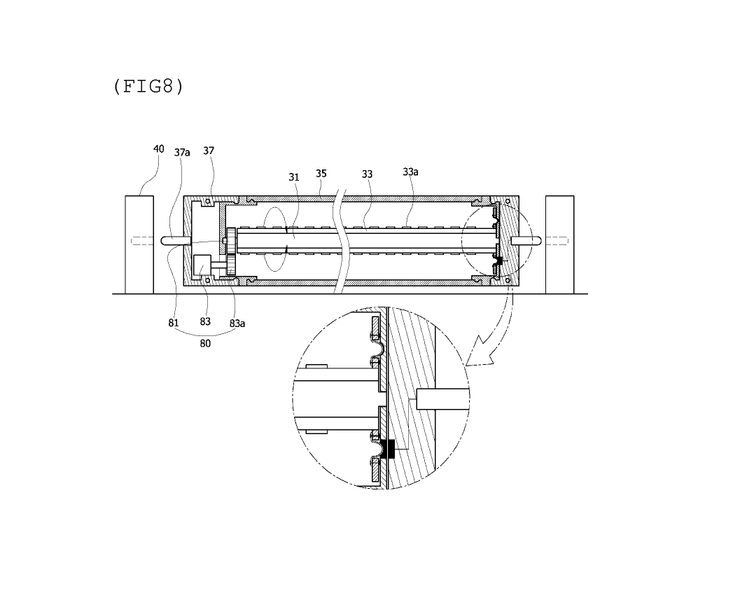

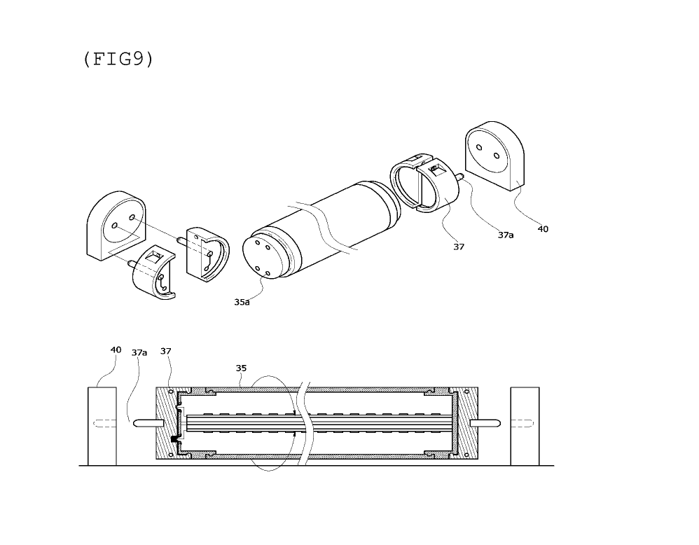

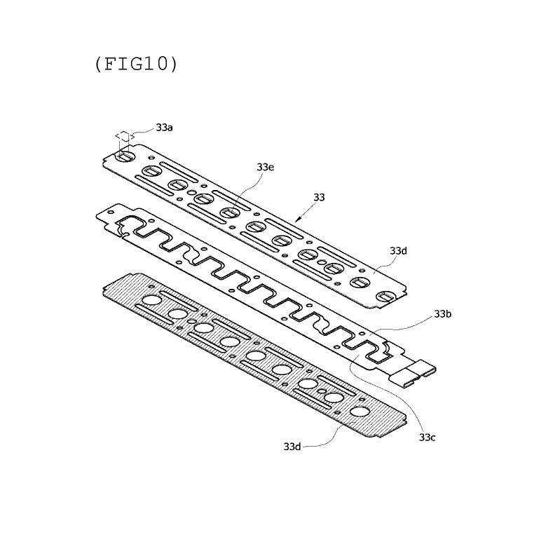

FIG. 2 is a perspective view the mounting state of a lighting device according to the present invention. FIG. 3(a)-(c) is an exploded view showing an LED lamp for a lighting device according to one embodiment of the present invention. FIG. 4 is an exploded view showing an LED lamp according to another embodiment of the present invention. FIGS. 5 and 6 are an exploded view and a side view showing an LED lamp according to still another embodiment of the present invention. FIG. 7 is a side view showing an LED lamp according to a first embodiment of the present invention. FIG. 8 is a side view showing an LED lamp according to a second embodiment of the present invention. FIG. 9 is a side view showing an LED lamp according to a third embodiment of the present invention. FIG. 10 is an exploded view showing an LED lighting substrate according to the present invention.

In a lighting device 1 according to the present invention, a plurality of straight-type LED lamps controlled through a control unit 20 are connected to a front surface of a casing 10 through a set of corresponding main sockets 40.

In addition, the straight-type LED lamp 30 has an assembling structure including a frame 31 having mounting parts 31a provided on at least two surfaces thereof, substrates 33 connected to the mounting parts 31a of the frame 31 and mounted thereon with LED chips 33a to have mutually different color temperatures, a Cover plate 35 mounted to cover at least a portion of the frame 31, and a unit socket 37 having at least two terminals 37a protruding for the electrical connection of at least one of the substrates 33 and supporting both end portions of the Cover plate 35.

In addition, the Cover plate 35 has a shape of a cylinder in which the frame 31 is inserted.

Further, the Cover plate 35, which has an arc shape, is connected to one lateral side of the frame 31.

In this case, the frame 31 has the mounting parts 31a arranged at an interval of 180° or 120°.

Further, main sockets 40 are mounted in the unit of a set to support both end portions of one LED lamp 30. The main socket 40 is mounted in such a manner that the main socket 40 is electrically connected to each substrate 330 when the main socket 40 is connected to the unit socket 37 of the LED lamp 30.

Meanwhile, the main sockets 40 include an electricity supply main socket to supply electricity and a dummy main socket.

In addition, the substrates 33 are connected to both main sockets 40 through mutually different terminals 37a of the unit sockets 37 mounted at both terminals of the LED lamp 30.

Further, one side of the substrate 33 is connected to the main socket through the unit socket 37 of the unit socket 37 mounted at one terminal of the LED lamp 30.

In addition, in the substrate 33, a plurality of positive and negative electrode plates 33b and 33c representing positive and negative polarities, respectively, are arranged in opposition to each other when viewed on a plan view in such a manner that the positive and negative electrode plates 33b and 33c are electrically isolated from each other while representing the minimum electricity-isolation area with respect to the whole area of the substrate 33.

In this case, insulating layers 33d are laminated on the top and the bottom of the positive and negative electrode plates 33b and 33c to cover the top and the bottom of the positive and negative electrode plates 33b and 33c.

Further, a plurality of grounding holes 33e are formed at one side of the insulating layer 33d to expose the positive and negative electrode plates 33b and 33c, and both polarities of the LED chips 33a are directly grounded through the grounding holes 33e to expose the electrode plates 33b and 33c that are electrically isolated from each other.

In this case, the electrically-isolated portions of the negative and positive electrode plates 33b and 33c, which are closely arranged in opposition to each other, form a zigzag pattern in which mutually different electrode plates are alternately arranged when viewed on a plan view.

Further, the lighting device 1 is mounted in such a manner that the Cover plate 35 having the frame 1 fixed thereto is rotated about the unit socket 37 used to supply power to the substrate 33 through the main socket 40.

In this case, contact points 35a connected to each substrate 33 are provided to both end portions of the Cover plate 35 such that the contact points 35a are exposed to both end portions of the Cover plate 35.

Further, the lighting device 1 is mounted in such a manner that the Cover plate 35 having the frame 31 fixed thereto is rotated about the unit socket 37 to supply power to the substrate 33 so that power is supplied through any one main socket 40 corresponding to the LED lamp 30.

In this case, the contact point 35a connected to each substrate 33 is provided at one end portion of the Cover plate 35 to be exposed to the end portion of the Cover plate 35.

Further, in the lighting device 1, the Cover plate 35 having the frame 31 fixed thereto is rotated by a first rotational unit 60 about the unit socket 37 to supply power to the substrate 33 through the main socket 40.

In this case, the contact points 35a connected to each substrate 33 are provided at both end portions of the Cover plate 35 to be exposed to the end portions of the Cover plate 35.

In addition, a plurality of substrates 33 mounted in the frame 31 receive power supplied through both unit sockets 37 connected to both sides of the LED lamp 30.

Further, the substrates 33 mounted in the frame 31 receive power supplied through one unit socket 37.

In addition, the first rotational unit 60 includes a first thread 61 formed around an inner circumference of the Cover plate 35 and a first driving motor 63 which is installed in the unit socket so that the first driving motor 63 is toothed with the first thread 61 and has a first driving gear 63a.

Meanwhile, in the light device 1, the frame 31 mounted in the Cover plate 35 to support the substrate 33 is rotated by a second rotational unit 80 when the Cover plate is connected to the unit socket 37 to supply power through the main socket 40.

In this case, the substrates 33 mounted in the frame 31 receive power supplied through the unit sockets 37 provided at both sides of the substrates 33.

In addition, the substrates 33 mounted in the frame 31 receive power supplied through one unit socket 37.

Further, the second rotational unit 80 includes a second thread 81 mounted while protruding from the frame 31 and a second driving motor 83 which is mounted in the unit socket 37 so that the second driving motor 83 is toothed with the second thread 81 and has a second driving gear 83a.

The control unit 20 includes a communication module 21 that makes wired or wireless communication to control each unit lighting device 1 by one controller 23. The control unit 20 is connected to a main control unit 20a to simultaneously or individually control whole blocks b.

Hereinafter, the operation of the present invention having the above structure will be described.

As shown in FIGS. 2 to 10, the lighting device 1 according to the present invention has a structure in which a plurality of LED lamps 30 controlled through a control unit 20 provided on a front surface of a casing 10 are connected to each other through a set of corresponding main sockets 40. The lighting device 1 forms a light source having a color temperature, such as warm and white, according to the connection state between the LED lamp 30 and the main socket 40.

In this case, the LED lamp 30 is provided in a straight type to form a light source having a color temperature, such as warm and white, according to the connection state between the LED lamp 30 and the main socket fixed to the LED lamp 30.

In addition, the LED lamp 30 forms the light source having the color temperature, such as warm and white, as the LED lamp 30 is connected to the main socket 30 by rotating the LED lamp 30, or by reversing the LED lamp 30.

The LED lamp 30 has an assembling structure including the frame 31 having mounting parts 31a provided on at least tow surfaces of the frame 31, the substrates 33 connected to the mounting parts 31a of the frame 31 and mounted thereon with LED chips 33a to have mutually different color temperatures, the Cover plate 35 mounted to cover at least a portion of the frame 31, and the unit socket 37 having at least two protruding terminals 37a provided for the electrical connection of at least one of the substrates 33 to support both ends of the Cover plate 35, and a light source having various color temperatures can be formed by using one LED lamp.

In addition, the Cover plate 35 to form a uniform external light source when light is emitted from the LED chip has the shape of a cylinder into which the frame to support the substrate is inserted, so that the Cover plate 35 has the shape the same as that of a typical fluorescent lamp.

In addition, the Cover plate 35, which has an arc shape, is connected to one lateral side of each frame 31. Accordingly, the Cover plate 35 may represent the same outer appearance as that of the typical fluorescent lamp and various designs may be provided to an outer portion of the Cover plate 35.

In this case, as the frame 31 has the mounting parts 31a arranged at an interval of 180° or 120°, LED chips having mutually different color temperatures may be mounted on the frame 31.

Further, the main socket 40 supplies power to only one substrate when both terminals of one LED lamp 30 are supported. Accordingly, as the LED lamp 30 is rotated, light sources having different color temperatures are provided.

Meanwhile, the main socket 40 serves as an electricity supply main socket to supply electricity or a dummy main socket according to the connection states of the LED lamp by differentially supplying power so that the color temperature such as warm and white can be represented through the control unit 20.

In this case, the substrate 33 is connected to one main socket through the unit socket 37 mounted at one end portion of the LED lamp 30.

In addition, the substrate 33 may perform the effective heat transfer by arranging the positive and negative electrode plates 33b and 33c, which represent positive and negative polarities, respectively, symmetrically to each other when viewed on a plan view in such a manner that the positive and negative electrode plates 33b and 33c are electrically isolated from each other while representing the minimum electricity-isolation area with respect to the whole area of the substrate 33.

In this case, the electrically-isolated portions of the negative and positive electrode plates 33b and 33c, which are closely arranged in opposition to each other, form a zigzag pattern in which mutually different electrode plates are alternately arranged when viewed on a plan view, thereby maximizing a heat transfer area.

Further, the lighting device 1 has a structure in which the Cover plate 35 of the LED lamp 30 supported through the main socket 40 is rotated or the frame 31 installed in the Cover plate 35 is rotated about the Cover plate 35, thereby forming a light source having a color temperature such as warm and white.

In this case, the frame 31 has the mounting parts 31a arranged at an interval of 180° or 120°, so that LED chips having mutually different color temperatures can be mounted on the mounting parts 31a.

In other words, if the Cover plate 35 having the frame fixed thereto is rotated about the unit socket 37 to supply power to the substrate 33, the contact point 35a connected to the substrate 33 is grounded through the contact point 35a of the unit socket 37 to supply power to the substrate 33.

Further, the lighting device 1 is mounted in such a manner that the Cover plate 35 having the frame 31 fixed thereto is rotated about the unit socket 37 to supply power to the substrate 33 so that power is supplied through any one main socket 40 corresponding to the LED lamp 30, thereby emitting light as power is supplied through the main sockets provided at both sides of the substrate 33 fixed to the frame when the Cover plate 35 is rotated.

Besides, in the lighting device 1, as a user automatically rotates the Cover plate 35 as described above instead of manually rotating the Cover plate 35, light sources having various color temperatures may be automatically provided.

In other words, the Cover plate 35 having the frame 31 fixed thereto is rotated by the first rotational unit 60 about the unit socket 37 to supply power to the substrate 33 through the main socket 40, so that the light source may be automatically provided.

In this case, the first rotational unit 60 includes the first thread 61 formed around an inner circumference of the Cover plate 35 and the first driving motor 63 which is installed in the unit socket so that the first driving motor 63 is toothed with the first thread 61 and has the first driving gear 63a, thereby rotating the Cover plate 35 when the first driving motor 63 is rotated.

Meanwhile, in the light device 1, the frame 31 mounted in the Cover plate 35 to support the substrate 33 is rotated by the second rotational unit 80 when the Cover plate 35 is connected to the unit socket 37 to supply power through the main socket 40, thereby providing a light source through automation.

Further, the second rotational unit 80 includes the second thread 81 mounted while protruding from the frame 31 and a second driving motor 83 which is mounted in the unit socket 37 so that the second driving motor 83 is toothed with the second thread 81 and has the second driving gear 83a, thereby rotating the frame 31 when the second driving motor is rotated.

The control unit 20 includes the communication module 21 that makes wired or wireless communication so that various color temperatures can be realized by an external remote signal. The controllers 23 installed in the lighting devices, respectively, are connected to each other, so that the automation for the whole block b of the lighting device 1 as well as each unit lighting device 1 can be selected through the manual manipulation of a user based on a previously input program.

What is claimed is:

1. A broadcast lighting device for adjusting a color temperature, the light broadcast lighting device comprising:
a plurality of straight-type LED lamps controlled through a control unit and connected to a front surface of a casing through a set of main sockets, respectively,
wherein each straight-type LED lamp comprises:
a frame having mounting parts provided on at least two surfaces thereof;
a substrate connected to the mounting part of the frame and mounted thereon with LED chips having mutually different color temperatures;
a Cover plate to cover at least a portion of the frame; and
a unit Side End Cap socket having at least two terminals protruding for electrical connection of at least one substrate and supporting both end portions of the Cover plate.

2. The broadcast lighting device of claim 1, wherein the Cover plate has a shape of a cylinder into which the frame is inserted.

3. The broadcast lighting device of claim 1, wherein the Cover plate is formed in a shape of an arc and connected to one lateral side of the frame.

4. The broadcast lighting device of claim 3, wherein the mounting parts of the frame are arranged at an interval of 180°.

5. The broadcast lighting device of claim 3, wherein the mounting parts of the frame are arranged at an interval of 120°

6. The broadcast lighting device of claim 1, wherein the set of the main sockets to support the straight-type LED lamps are electrically connected to each other when the straight-type LED lamps are connected to each other.

7. The broadcast lighting device of claim 1, wherein the set of the main sockets to support the straight-type LED lamps comprise a main socket to supply electricity and a dummy main socket.

8. The broadcast lighting device of claim 1, wherein the substrate is connected to both main sockets through mutually different terminals of both unit Side End Cap sockets.

9. The broadcasting Lighting Device of claim 1, where Neutral Side of the Main Soket (40a) is connected to one of the terminal of Side End Cap (37b) for Front Side LED Plate lighting.
One connection for each one main socket of terminal for AC Power supply for one side LED Lighting

10. The Broadcasting Lighting Device of claim 9, where the Neutral Side of the Main Soket (40b) is connected to one of the terminal of Side End Cap (37a) for Back Side LED Plate lighting.
One connection for each one main socket of terminal for AC Power supply for one side LED Lighting.

11. The broadcast lighting device of claim 1, wherein one side of the substrate is connected to the main socket through a terminal of the main socket.

12. The broadcast lighting device of claim 1, wherein the substrate comprises a plurality of electrode plates representing positive and negative polarities, respectively, are arranged in opposition to each other when viewed on a plan view such that the electrode plates are electrically isolated from each other while representing a minimum electricity-isolation area with respect to a whole area of the substrate, insulating layers are laminated on a top and a bottom of the electrode plates to cover the top and the bottom of the electrode plates,
a plurality of grounding holes are formed at one side of the insulating layer to expose the electrode plates, both polarities of the LED chips are directly grounded through the grounding holes to expose the electrode plates that are electrically isolated from each other, and electrically-isolated portions of the electrode plates, which are closely arranged in opposition to each other, form a zigzag pattern in which mutually different electrode plates are alternately arranged when viewed on a plan view.

13. The broadcast lighting device of claim 1, wherein the LED lamp is mounted to rotate the Cover plate having the frame fixed thereto about the unit socket to supply power to the substrate through the main sockets, and contact points connected to each substrate are provided at both end portions of the Cover plate such that the contact points are exposed.

14. The broadcast lighting device of claim 1, wherein the LED lamp is mounted to rotate the Cover plate having the frame fixed thereto about the unit socket to supply power to the substrate through one of the main sockets, and contact points connected to each substrate are provided at both end portions of the Cover plate such that the contact points are exposed.

15. The broadcast lighting device of claim 1, wherein the LED lamp is mounted to rotate the Cover plate having the frame fixed thereto about the unit socket by a first rotational unit to supply power to the substrate through a corresponding main socket, and contact points connected to each substrate are provided at both end portions of the Cover plate such that the contact points are exposed.

16. The broadcast lighting device of claim 14, wherein a plurality of substrates mounted in the frame receive power through unit sockets provided at both sides of the substrates.

17. The broadcast lighting device of claim 13, wherein a plurality of substrates mounted in the frame receive power through one unit socket.

18. The broadcast lighting device of claim 13, wherein the first rotational unit comprises a first thread formed around an inner circumference of the Cover plate and a first driving motor which is installed in the unit socket and has a first driving gear.

19. The broadcast lighting device of claim 1, wherein the LED lamp is mounted to rotate the frame, which is mounted in the Cover plate to support the substrate, by a second rotational unit when the Cover plate is connected to the unit socket to supply power through a corresponding main socket.

20. The broadcast lighting device of claim 19, wherein a plurality of substrates mounted in the frame of the LED lamp receive power through unit sockets provided at both sides of the substrates.

21. The broadcast lighting device of claim 19, wherein a plurality of substrates mounted in the frame of the LED lamp receive power through one unit socket.

22. The broadcast device of claim 19, wherein the second rotational unit comprises a second thread protruding from the frame and a second driving motor which is mounted in the unit socket and has a second driving gear.

23. The broadcast lighting device of claim 1, wherein the control unit comprises a communication module that makes wired or wireless communication to control all unit lighting devices or individually control the unit lighting devices by one controller.
